(19) United States
(12) Patent Application Publication
(10) Pub. No.: US 2025/0330464 A1
(43) Pub. Date: Oct. 23, 2025

(54) METHOD AND APPARATUS FOR PROVIDING PROGRESSIVE WEB APPLICATION, ELECTRONIC DEVICE, AND STORAGE MEDIUM

(71) Applicant: Beijing Zitiao Network Technology Co., Ltd., Beijing (CN)

(72) Inventors: Yongsen SHAO, Beijing (CN); Wei LU, Beijing (CN); Fukang LIU, Beijing (CN); Yang YANG, Beijing (CN); Qi QI, Beijing (CN)

(21) Appl. No.: 19/171,974

(22) Filed: Apr. 7, 2025

(30) Foreign Application Priority Data
Apr. 19, 2024 (CN) 202410479680.3

(51) Int. Cl. H04L 9/40

(52) U.S. Cl. CPC H04L 63/0876; H04L 63/126

(57) ABSTRACT

Provided are a method and apparatus for providing a progressive web application, an electronic device, and a storage medium. The method includes: determining whether a first website visited by a user through a browser supports the progressive web application; in accordance with a determination that the first website supports the progressive web application, sending a request to an application packaging service in response to a preset operation of the user, such that the application packaging service generates, based on web application configuration information of the first website and preset field information, an application package of a progressive web application of the first website; acquiring the application package; and installing the progressive web application of the first website based on the application package.

### CROSS-REFERENCE TO RELATED APPLICATION(S)

This application claims priority to Chinese Application No. 202410479680.3 filed on Apr. 19, 2024, the disclosure of which is incorporated herein by reference in its entirety.

### FIELD

The present disclosure relates to the field of computer technologies, and in particular, to a method and apparatus for providing a progressive web application, an electronic device, and a storage medium.

### BACKGROUND

A Progressive Web Application (abbreviated as “PWA”), also known as a gradually approaching native program, is an application form that combines a web page and a native application, so that the web page has experience of a native application, e.g., including functions such as offline access, push notifications, and fast loading.

### SUMMARY

This Summary is provided to introduce concepts in a simplified form that are described in detail in the following Detailed Description. This Summary is not intended to identify key features or essential features of the claimed technical solutions, nor is it intended to be used to limit the scope of the claimed technical solutions.

In a first aspect, according to one or more embodiments of the present disclosure, a method for providing a progressive web application is provided, including: determining whether a first website visited by a user through a browser supports the progressive web application; in accordance with a determination that the first website supports the progressive web application, sending a request to an application packaging service in response to a preset operation of the user, such that the application packaging service generates, based on web application configuration information of the first website and preset field information, an application package of the progressive web application of the first website; acquiring the application package; and installing the progressive web application of the first website based on the application package.

In a second aspect, according to one or more embodiments of the present disclosure, a method for providing a progressive web application is provided, including: acquiring, in response to a request sent by a browser, web application configuration information of a first website visited by the browser; determining preset field information, where the preset field information includes at least one of: display mode information, an application packaging unique identifier, or target control state information; generating, based on the web application configuration information and the preset field information, an application package of a progressive web application of the first website; and sending the application package to the browser.

In a third aspect, according to one or more embodiments of the present disclosure, an apparatus for providing a progressive web application is provided, including: a determination unit, configured to determine whether a first website visited by a user through a browser supports the progressive web application; a request unit, configured to in accordance with a determination that the first website supports the progressive web application, send a request to an application packaging service in response to a preset operation of the user, such that the application packaging service generates, based on web application configuration information of the first website and preset field information, an application package of the progressive web application of the first website; an acquisition unit, configured to acquire the application package; and an installation unit, configured to install the progressive web application of the first website based on the application package.

In a fourth aspect, according to one or more embodiments of the present disclosure, an apparatus for providing a progressive web application is provided, including: an acquisition unit, configured to acquire, in response to a request sent by a browser, web application configuration information of a first website visited by the browser; a determination unit, configured to determine preset field information, where the preset field information includes at least one of: display mode information, an application packaging unique identifier, or target control state information; a generation unit, configured to generate, based on the web application configuration information and the preset field information, an application package of a progressive web application of the first website; and a sending unit, configured to send the application package to the browser.

In a fifth aspect, according to one or more embodiments of the present disclosure, an electronic device is provided, including: at least one memory and at least one processor; where the memory is configured to store program code, and the processor is configured to invoke the program code stored in the memory to cause the electronic device to perform the method for providing a progressive web application provided according to one or more embodiments of the present disclosure.

In a sixth aspect, according to one or more embodiments of the present disclosure, a non-transitory computer storage medium is provided, where the non-transitory computer storage medium stores program code, and the program code, when executed by a computer device, causes the computer device to perform the method for providing a progressive web application provided according to one or more embodiments of the present disclosure.

### BRIEF DESCRIPTION OF THE DRAWINGS

The above and other features, advantages and aspects of various embodiments of the present disclosure will become more apparent when taken in conjunction with the drawings and with reference to the following detailed description. Throughout the drawings, the same or similar reference numbers refer to the same or similar elements. It should be understood that the drawings are schematic and that the components and elements are not necessarily drawn to scale.

FIG. 1 is a schematic flowchart of a method for providing a progressive web application according to an embodiment of the present disclosure;

FIG. 2 is a schematic flowchart of a method for providing a progressive web application according to another embodiment of the present disclosure;

FIG. 3 is a schematic flowchart of a method for providing a progressive web application according to yet another embodiment of the present disclosure;

FIG. 4 is an optional schematic diagram of a virtual field of view of an extended reality device according to an embodiment of the present disclosure;

FIG. 5 is a schematic structural diagram of an apparatus for providing a progressive web application according to an embodiment of the present disclosure;

FIG. 6 is a schematic structural diagram of an apparatus for providing a progressive web application according to another embodiment of the present disclosure; and

FIG. 7 is a schematic structural diagram of an electronic device according to an embodiment of the present disclosure.

### DETAILED DESCRIPTION

Embodiments of the present disclosure will be described in more detail below with reference to the drawings. Although some embodiments of the present disclosure are shown in the drawings, it should be understood that the present disclosure may be implemented in various forms and should not be construed as being limited to the embodiments set forth herein. On the contrary, these embodiments are provided for a more thorough and complete understanding of the present disclosure. It should be understood that the drawings and embodiments of the present disclosure are only for exemplary purposes and are not intended to limit the scope of protection of the present disclosure.

It should be understood that the steps described in the implementations of the present disclosure may be performed in different orders and/or in parallel. In addition, the implementations may include additional steps and/or omit performing the illustrated steps. The scope of the present disclosure is not limited in this respect.

The term “include/include” and its variations used herein are open-ended inclusions, that is, “include/include but not limited to”. The term “based on” is “at least partially based on”. The term “one embodiment” means “at least one embodiment”; the term “another embodiment” means “at least one other embodiment”; and the term “some embodiments” means “at least some embodiments”. The term “in response to” and related terms refer to a signal or event being affected by another signal or event to a certain extent, but not necessarily completely or directly. If event x is “in response to” event y, then x may be directly or indirectly in response to y. For example, the occurrence of y may ultimately lead to the occurrence of x, but there may be other intermediate events and/or conditions. In other cases, y may not necessarily lead to the occurrence of x, and x may occur even if y has not occurred. In addition, the term “response to” may also mean “at least partially response to”.

The term “determine/determination” widely covers a variety of actions, which may include acquisition, calculation, processing, derivation, investigation, search (e.g., search in a table, a database or other data structures), exploration, and similar actions, and may also include reception (e.g., reception of information), accessing (e.g., accessing data in the memory) and similar actions, as well as parsing, selection, choosing, establishing and similar actions, etc. Related definitions of other terms will be given in the following description.

It should be noted that concepts such as “first” and “second” mentioned in the present disclosure are only used to distinguish different apparatuses, modules or units, and are not used to limit the sequence of functions performed by these apparatuses, modules or units or the interdependence therebetween.

It should be noted that the modifiers of “one” and “a plurality of” mentioned in the present disclosure are illustrative rather than restrictive, and those skilled in the art should understand that they should be understood as “one or more” unless clearly indicated in the context. For the purposes of the present disclosure, the phrase “A and/or B” means (A), (B), or (A and B).

The names of messages or information exchanged between apparatuses in the implementations of the present disclosure are only for illustrative purposes, and are not intended to limit the scope of the messages or information.

It should be noted that the step of acquiring the user's personal data mentioned in the present disclosure is performed with the user's authorization. For example, in response to receiving an active request from the user, prompt information is sent to the user to clearly prompt the user that the operation requested to be performed will require the acquisition and use of the user's personal information. Thereby, the user can independently choose whether to provide the personal information to software or hardware such as the electronic device, the application, the server or the storage medium that performs the operations of the technical solution of the present disclosure according to the prompt information. As an optional but non-limiting implementation, the manner of sending the prompt information to the user in response to receiving the active request from the user may be, for example, a pop-up window, and the prompt information may be presented in text in the pop-up window. In addition, the pop-up window may further include a selection control for the user to select “agree” or “disagree” to provide the personal information to the electronic device. It should be understood that the above process of notifying and acquiring the user's authorization is only illustrative and does not constitute a limitation on the implementations of the present disclosure, and other manners that meet relevant laws and regulations may also be applied to the implementations of the present disclosure. It should be understood that the data involved in the technical solution (including but not limited to the data itself, the acquisition or use of the data) should comply with requirements of corresponding laws and regulations and related provisions.

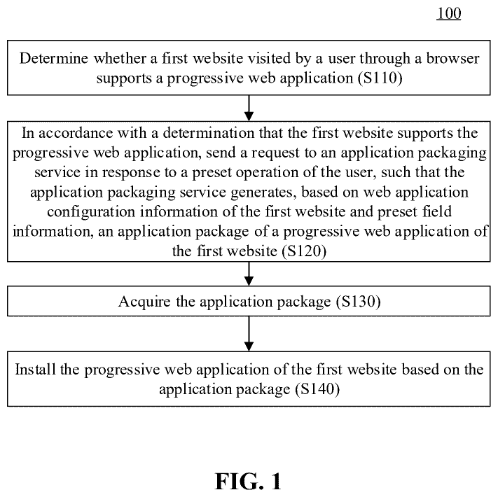

Referring to FIG. 1, which illustrates a flowchart of a method 100 for providing a progressive web application according to an embodiment of the present disclosure. In some embodiments, the method 100 is executed at an electronic device, and the electronic device may communicate with a display generation component (e.g., a display screen) and one or more input devices (e.g., a handheld controller, an eye tracking device, a hand tracking device, a camera, or other input devices). In some embodiments, the display generation component may be integrated on the electronic device, and the input device may be integrated on or external to the electronic device, but the present disclosure is not limited thereto.

The method 100 includes steps S110-S140: Step S110: it is determined whether a first website visited by a user through a browser supports a progressive web application; Step S120: in accordance with a determination that the first website supports the progressive web application, a request is sent to an application packaging service in response to a preset operation of the user, such that the application packaging service generates, in response to the request based on web application configuration information of the first website and a preset field, an application package of a progressive web application of the first website; Step S130: the application package is acquired; and Step S140: the progressive web application of the first website is installed based on the application package.

The first website is a website that the user is currently accessing through the browser. The preset operation is used to trigger an instruction to install the progressive web application of the first website. Exemplarily, the user may trigger, through a body-sense control operation, a gesture control operation, an eyeball shaking operation, a touch operation, a voice operation, or an operation on an external control device (such as a handle), the instruction to install the progressive web application.

In some embodiments, when the user opens the first website in the browser, the browser detects the website. If the first website supports generating the progressive web application, an identifier for installing the progressive web application of the first website may be displayed at a preset location of the browser. After the user triggers the identifier through the preset operation, the browser requests in the background the application packaging service to generate the application package of the progressive web application of the first website. After receiving the request, the application packaging service generates the application package based on the web application configuration information of the first website and the preset field, and sends the application package to the browser. The browser downloads and installs the application package, and finally displays an application icon and a name on a user graphic interface (such as a desktop). The user can use the web application as a native application by clicking on the application icon to open the application.

In some embodiments, when parsing the web page of the website, the browser may determine whether the first website supports the progressive web application feature by determining whether the website has a configuration file corresponding to the progressive web application. For example, the configuration file may be a Web Application Manifest file, which defines basic information of the progressive web application, such as a name, an icon, a theme color, a splash screen, etc. In some embodiments, it is further possible to determine whether the first website supports the progressive web application feature in combination with fields in the configuration file (e.g., a website startup URL, an application icon, etc.).

In this way, according to one or more embodiments of the present disclosure, by determining whether the first website visited by the browser supports the progressive web application, and in accordance with a determination that the first website supports the progressive web application, sending the request to the application packaging service in response to the preset operation of the user, such that the application packaging service generates the application package of the progressive web application of the first website based on the web application configuration information of the first website and the preset field information, and installing the progressive web application of the first website based on the application package, the user can be provided with the progressive web application that approaches the native application.

In some embodiments, the preset field information includes a packaging unique identifier. In the process of generating the application package of the progressive web application of the first website, the application packaging service may generate the packaging unique identifier through a preset encryption algorithm based on a start address (e.g., a start URL) and a name (e.g., an application package name) of the application, so as to generate the application package with the packaging unique identifier. The packaging unique identifier may be used in an authentication step after the application is started.

In a specific implementation, the encryption algorithm may be an asymmetric encryption algorithm (e.g., an RSA algorithm).

In a specific implementation, in the process of generating the application package of the progressive web application, the packaging service may fill in the packaging unique identifier into a predefined corresponding field (e.g., a packaging unique identifier field) in the template project.

Further, in some embodiments, in response to an instruction of the user to start the progressive web application of the first website, the authentication may be performed based on the packaging unique identifier. And in accordance with a determination that the authentication succeeds, the progressive web application of the first website is continued to be run, or in accordance with a determination that the authentication fails, the progressive web application of the first website is stopped running. For example, the packaging unique identifier may be decrypted by using an asymmetric encryption algorithm (e.g., an RSA algorithm) to obtain a start address (e.g., a start URL) and a name (e.g., an application package name) of the application, and a comparison verification is performed between the start address obtained through decryption and an actual start address when the application is actually run, and between the name obtained through decryption and an actual name (e.g., an application package name), and if the comparison verification results of the two times are consistent, each other, the authentication succeeds.

According to one or more embodiments of the present disclosure, by generating the packaging unique identifier in the process of generating the application package, and performing the authentication based on the packaging unique identifier when the application is running, the security and consistency of using the progressive web application can be ensured.

Further, the preset field information includes display mode information. After the authentication succeeds, the display mode information in the application package is parsed, and a display mode of the progressive web application of the first website is determined based on the parsed display mode information. Different display modes may present different user interface styles. In some embodiments, a loading interface of the progressive web application of the first website may also be generated based on the parsed display mode information.

Exemplarily, for a 2D progressive web application, a first display mode or a second display mode may be provided. In the first display mode, an address bar and a navigation control of a browser are not displayed in an application interface, so that a use experience close to that of a native application may be provided; and in the second display mode, preset controls (e.g., a return control, a refresh control) are provided at a preset position of the application interface.

For a 3D progressive web application, a third display mode may be provided, the third display mode may provide an application loading interface after the application is started, and an application icon and a name may be displayed on the application loading page. After the user clicks on the icon of the 3D progressive web application, the application loading interface is displayed, and after the 3D progressive web application is loaded, a 3D environment provided by the 3D progressive web application is entered. Since the loading time of the 3D progressive web application is long, by displaying the application loading interface provided by the third display mode after the application is started, the user can be provided with more immersive use experience of the web application.

In some embodiments, after the progressive web application is started, online configuration information and local configuration information corresponding to the progressive web application may also be acquired; the local configuration information is compared with the online configuration information, and whether to update the locally installed progressive web application is determined based on a comparison result. For example, in a process of running the progressive web application, the browser will perform update detection on the progressive web application in the background: reading Web App Manifest information of the application from a metadata tag in a core configuration file (e.g., Manifest.xml) of the progressive web application, and comparing the information with information in a Web Application Manifest file online of the first website, including comparing values of various fields, and comparing whether image data of the application icon and the application name have changed, to determine whether the application needs to be updated. If an update is required, the browser will request the application packaging service to generate a new application package, and then download the application package and perform silent installation and upgrade. In a specific implementation, even if the values of the fields do not change, if the image data of the application icon or the application name changes, the change can still be detected and the application can be updated, thereby realizing dynamic update of the icon and the name of the progressive web application.

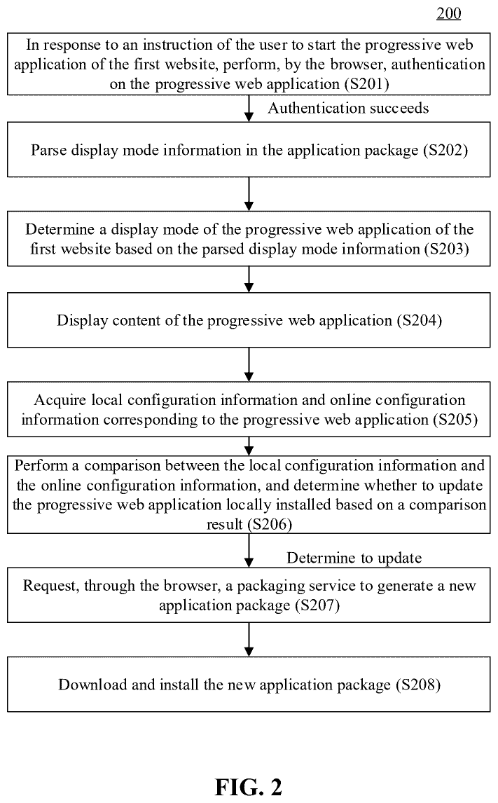

Referring to FIG. 2, which illustrates a flowchart of a method 200 for providing a progressive web application according to an embodiment of the present disclosure.

In step S201, the browser performs authentication on the progressive web application in response to an instruction of the user to start the progressive web application of the first website. If the authentication succeeds, step S202 is performed.

In step S202, the display mode information in the application package is parsed.

In step S203, a display mode of the progressive web application of the first website is determined based on the parsed display mode information.

In step S204, content of the progressive web application is displayed.

In step S205, online configuration information and local configuration information corresponding to the progressive web application are acquired.

In step S206, the local configuration information is compared with the online configuration information, and whether to update the progressive web application locally installed is determined based on a comparison result. If the determination is yes, step S207 is performed.

In step S207, the packaging service is requested through the browser to generate a new application package.

In step S208, the new application package is downloaded and installed.

In some embodiments, the preset field information further includes target control state information. After the authentication succeeds, the target control state information in the preset field is parsed, and an event corresponding to the target control is triggered based on the target control state information. Exemplarily, if the target control state information indicates that the target control is in a triggered state, an event corresponding to the target control in the triggered state may be automatically performed after the application is started, without the user manually triggering the control. For example, if the target control is a button control used to cause a 3D progressive web application to display a 3D interface, and if the target control state information is used to indicate a selected state of the target control, then the 3D interface may be automatically entered after the progressive web application is started, without the user manually selecting the button control.

In some embodiments, the browser reads preset field information from a metadata tag in a configuration file (e.g., Manifest.xml) in the application package of the progressive web application, where the preset field information includes the display mode information, the application packaging unique identifier, or the target control state information.

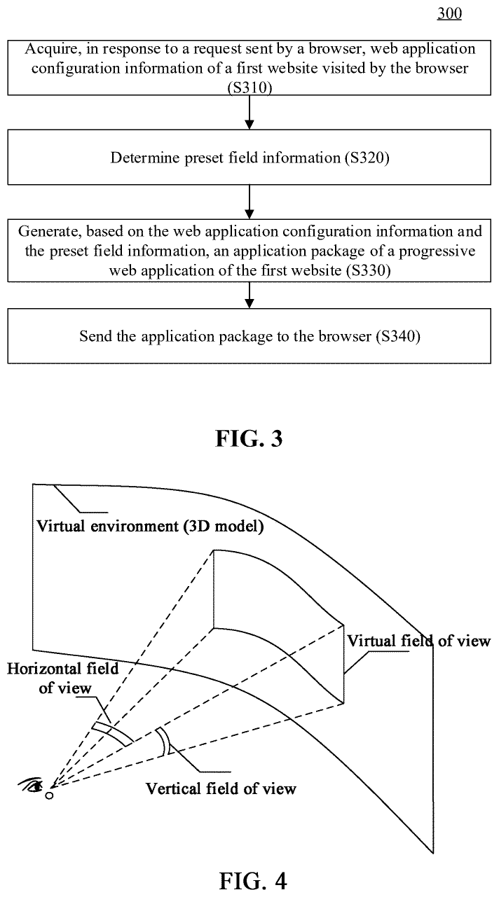

Referring to FIG. 3, which illustrates a flowchart of a method 300 for providing a progressive web application according to an embodiment of the present disclosure.

In step S310, in response to a request sent by a browser, web application configuration information of a first website visited by the browser is acquired; In step S320, preset field information is determined, where the preset field information includes at least one of: display mode information, an application packaging unique identifier, or target control state information; In step S330, an application package of a progressive web application of the first website is generated based on the web application configuration information and the preset field information; and In step S340, the application package is sent to the browser.

In some embodiments, the method 300 may be used for the application packaging service. In some embodiments, after receiving the request, the application packaging service parses the configuration file (e.g., the aforementioned Web Application Manifest file) of the first website corresponding to the progressive web application to obtain the web application configuration information, and fills the web application configuration information and the preset field information (e.g., the display mode information, the application packaging unique identifier, or the target control state information) into the preset template project through a packaging tool to generate a complete project project, and then compiles the project project to obtain the application installation package. The template project is used to provide a preset structure, configuration, code framework, component integration, or other development specifications for an application development project. Exemplarily, the template project may include elements such as a standard file organization structure, a necessary dependency library, a basic function module, a code skeleton that follows a certain design pattern or best practice, a specific development tool chain, a test framework, or a script. In a specific implementation, a core configuration file (e.g., Manifest.xml) in the template project file has predefined preset fields, including fields corresponding to the display mode, the packaging unique identifier, or the target control state.

In some embodiments, the generation of the application package may be compiled through a build script in combination with a software development kit (SDK), but the present disclosure is not limited thereto.

In some embodiments, if the progressive web application of the first website is a 2D application, the template project thereof does not include an application startup image of the 2D application, thereby greatly reducing the size of the application package. Correspondingly, the progressive web application will no longer display the application startup image when starting.

In some embodiments, the application packaging service generates the packaging unique identifier through a preset encryption algorithm based on a start address (e.g., a start URL) and a name (e.g., an application package name) of the application, and the packaging unique identifier may be used in an authentication step when the application is started. In a specific implementation, the encryption algorithm may be an asymmetric encryption algorithm (e.g., an RSA algorithm).

In some embodiments, the display mode information is determined based on a type of the progressive web application of the first website. Exemplarily, if the progressive web application is a 2D application, the display mode information may include information indicating a first display mode or information indicating a second display mode. If the first website is a 3D application, the display mode information may include information indicating a third display mode. In the first display mode, an address bar and a navigation control of a browser are not displayed in an application interface, so that a use experience close to that of a native application may be provided. In the second display mode, preset controls (e.g., a return control, a refresh control) are provided at a preset position of the application interface. In the third display mode, an application loading interface may be provided after the application is started, and an application icon and a name may be displayed on the application loading page. After the user clicks on the icon of the application, the application loading interface is displayed, and after the 3D progressive web application is loaded, a corresponding 3D interface is entered.

In some embodiments, when generating the application package, the application packaging service may further be used to generate, in the project code of the installation package, a package name of a target application is specified, such that the progressive web application is capable of being associated with the target application when being run. In some embodiments, the target application includes a target browser, so as to implement that the progressive web application of the first website is opened by the target browser by default.

In some embodiments, it may be further detected in the local device whether the target application is installed, and if the target application is installed, the package name of the target application may be specified through the application packaging service.

In some embodiments, the acquired installation package of the progressive web application may also be uploaded to an application store, so as to enrich the application ecosystem of the platform.

The method for providing a progressive web application provided by one or more embodiments of the present disclosure is applied to an extended reality (XR for short) scenario. Extended reality may combine the real with the virtual through a computer to provide the user with a virtual reality space for human-computer interaction. The user may enter the virtual reality space through an extended reality device such as a head-mounted display, and access websites, download and use the progressive web application in the virtual reality space.

The extended reality device described in the embodiments of the present disclosure may include, but is not limited to, the following types:
a computer-side extended reality device, which utilizes a PC side to perform calculations related to an extended reality function and data output, and an external computer-side extended reality device utilizes data output by the PC side to achieve an effect of the extended reality.
a mobile extended reality device, which supports setting a mobile terminal (such as a smart phone) in various ways (such as a head-mounted display provided with a dedicated card slot), and through a wired or wireless connection with the mobile terminal, the mobile terminal performs calculations related to the extended reality function, and outputs data to the mobile extended reality device, for example, watching an extended reality video through an APP of the mobile terminal.
an all-in-one extended reality device, which is provided with a processor for performing calculations related to a virtual function, and thus has independent functions of extended reality input and output, does not need to be connected to a PC side or the mobile terminal, and has high freedom of use.

Of course, the form implemented by the extended reality device is not limited to this, and may be further miniaturized or large-scaled as required.

The extended reality device is provided with a sensor for posture detection (such as a nine-axis sensor), which is configured to detect in real time a posture change of the extended reality device. If the user wears the extended reality device, when a head posture of the user changes, a real-time posture of the head will be transmitted to the processor, so as to calculate a gaze point of the user's sight in the virtual environment, calculate, according to the gaze point, an image in a three-dimensional model of the virtual environment within the gaze range of the user (that is, the virtual field of view), and display the image on the display screen, so that the user has an immersive experience as if the user is watching in a real environment.

FIG. 4 illustrates an optional schematic diagram of a virtual field of view of an extended reality device according to an embodiment of the present disclosure. The distribution range of the virtual field of view in the virtual environment is described with a horizontal field of view and a vertical field of view. The distribution range in the vertical direction is represented by a vertical field of view BOC, and the distribution range in the horizontal direction is represented by a horizontal field of view AOB. The human eyes can always perceive an image located in the virtual field of view in the virtual environment through the lens. It can be understood that the larger the field of view, the larger the size of the virtual field of view, and the larger the area of the virtual environment that the user can perceive. The field of view represents the distribution range of viewing angles when the environment is perceived through the lens. For example, the field of view of the extended reality device represents the distribution range of viewing angles of the human eye when the virtual environment is perceived through the lens of the extended reality device. For another example, for a mobile terminal provided with a camera, the field of view of the camera is the distribution range of viewing angles when the camera performs capturing by perceiving the real environment.

The extended reality device, such as the HMD, is integrated with several cameras (such as a depth camera, an RGB camera, etc.), and the purpose of the cameras is not limited to providing a see-through view. The camera images and an integrated inertial measurement unit (IMU) provide data that can be processed by computer vision methods to automatically analyze and understand the environment. Also, the HMD is designed to support not only passive computer vision analysis, but also active computer vision analysis. The passive computer vision method analyzes image information captured from the environment. These methods may be monoscopic (images from a single camera) or stereoscopic (images from two cameras). They include, but are not limited to, feature tracking, object recognition, and depth estimation. The active computer vision method adds information to the environment by projecting a pattern that is visible to the camera but not necessarily visible to the human visual system. Such techniques include time-of-flight (ToF) cameras, laser scanning, or structured light to simplify the stereo matching problem. Active computer vision is used to implement scene depth reconstruction.

According to one or more embodiments of the present disclosure, by using the method for providing a progressive web application provided by the embodiments of the present disclosure in an extended reality device, an application ecosystem of an extended reality system can be enriched. In a specific implementation, the browser in the foregoing embodiments may be a mobile browser, such as a Chromium-based browser, so that a PWA website is packaged into an application package (e.g., an Android application package, APK) through the mobile browser for installation and running, and the PWA application is more in line with an extended reality application scenario through the setting of the display mode information.

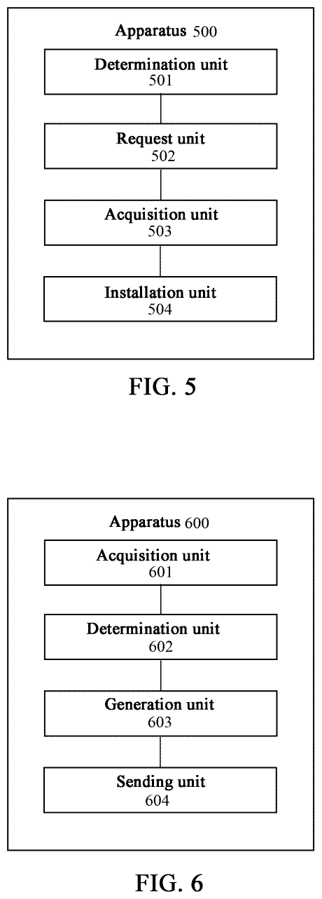

Correspondingly, referring to FIG. 5, an apparatus 500 for providing progressive web application is provided according to an embodiment of the present disclosure, including: a determination unit 501, configured to determine whether a first website visited by a user through a browser supports the progressive web application; a request unit 502, configured to in accordance with a determination that the first website supports the progressive web application, send a request to an application packaging service in response to a preset operation of the user, such that the application packaging service generates, based on web application configuration information of the first website and preset field information, an application package of a progressive web application of the first website; an acquisition unit 503, configured to acquire the application package; and an installation unit 504, configured to install the progressive web application of the first website based on the application package.

In some embodiments, the preset field information includes a packaging unique identifier, and the apparatus further includes: an authentication unit, configured to in response to an instruction for starting the progressive web application of the first website, perform authentication based on the packaging unique identifier; and in accordance with a determination that the authentication succeeds, continue to run the progressive web application of the first website, or in accordance with a determination that the authentication fails, stop running the progressive web application of the first website.

In some embodiments, the packaging unique identifier is generated through encryption based on a start address and a name of the progressive web application of the first website; and the authentication unit includes: a decryption subunit, configured to decrypt, based on the packaging unique identifier, to obtain the start address and the name of the progressive web application of the first website; and a verification subunit, configured to perform a comparison verification between the start address obtained through decryption and an actual start address when the application is actually run, and between the name obtained through decryption and an actual name.

In some embodiments, the preset field information includes display mode information, and the apparatus further includes: a display mode parsing unit, configured to after the authentication succeeds, parse the display mode information in the application package; and a display mode determination unit, configured to determine, based on the parsed display mode information, a display mode of the progressive web application of the first website.

In some embodiments, based on determining that the progressive web application of the first website is a 2D progressive web application, the progressive web application of the first website has different user interface styles in different display modes.

In some embodiments, based on determining that the progressive web application is a 3D progressive web application, the determining, based on the parsed display mode information, a display mode of the progressive web application of the first website includes: generating, based on the parsed display mode information, a loading interface of the progressive web application of the first website.

In some embodiments, the preset field information includes target control state information; and the apparatus further includes: a control state parsing unit, configured to after the authentication succeeds, parse the target control state information in the application package; and an event execution unit, configured to trigger, based on the target control state information, an event corresponding to a target control.

In some embodiments, the apparatus further includes an update detection unit, configured to: after the progressive web application is started, acquire local configuration information and online configuration information corresponding to the progressive web application of the first website; compare the local configuration information with the online configuration information; and determine, based on a comparison result, whether to update the progressive web application of the first website.

Correspondingly, referring to FIG. 6, an apparatus 600 for providing progressive web application is provided according to an embodiment of the present disclosure, including: an acquisition unit 601, configured to acquire, in response to a request sent by a browser, web application configuration information of a first website visited by the browser; a determination unit 602, configured to determine preset field information, where the preset field information includes at least one of: display mode information, an application packaging unique identifier, or target control state information; a generation unit 603, configured to generate, based on the web application configuration information and the preset field information, an application package of a progressive web application of the first website; and a sending unit 604, configured to send the application package to the browser.

In some embodiments, the apparatus further includes: an encryption unit, configured to generate, through a preset encryption algorithm based on a start address and a name of the progressive web application of the first website, the packaging unique identifier.

In some embodiments, the determination unit includes: a display mode determination subunit, configured to determine, based on a type of the progressive web application of the first website, the display mode information.

In some embodiments, the apparatus further includes: an application association unit, configured to specify, in the project code of the progressive web application, a package name of the target application, such that the progressive web application is capable of being associated with the target application when being run.

For the embodiments of the apparatus, since they basically correspond to the method embodiments, reference may be made to parts of the description of the method embodiments for relevant parts. The above-described apparatus embodiments are only illustrative, and the modules described as separate modules may be separate or may not be separate. Some or all of them may be selected according to actual needs to achieve the purpose of the solution of the present embodiment. Those of ordinary skill in the art can understand and implement without paying creative efforts.

Accordingly, according to one or more embodiments of the present disclosure, an electronic device is provided, including: at least one memory and at least one processor; where the memory is configured to store program code, and the processor is configured to invoke the program code stored in the memory to cause the electronic device to perform the method for providing a progressive web application provided according to one or more embodiments of the present disclosure.

Accordingly, according to one or more embodiments of the present disclosure, a non-transitory computer storage medium is provided, where the non-transitory computer storage medium stores program code, and the program code, when executed by a computer device, causes the computer device to perform the method for providing a progressive web application provided according to one or more embodiments of the present disclosure.

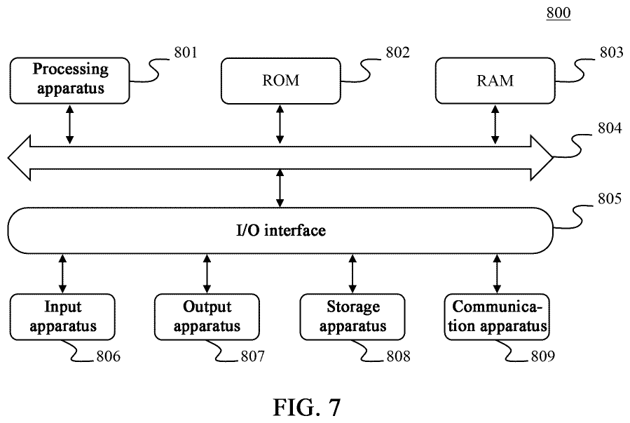

Referring to FIG. 7 below, which illustrates a schematic structural diagram of an electronic device 800 suitable for implementing the embodiments of the present disclosure. The electronic device shown in FIG. 7 is only one example, and should not bring any limitation to the functions and scope of use of the embodiments of the present disclosure.

As shown in FIG. 7, the electronic device 800 may include a processing apparatus (e.g., a central processing unit, a graphics processing unit, etc.) 801, which may perform various appropriate actions and processes according to a program stored in a read-only memory (ROM) 802 or a program loaded from a storage apparatus 808 into a random access memory (RAM) 803. In the RAM 803, various programs and data required for the operation of the electronic device 800 are also stored. The processing apparatus 801, ROM 802, and RAM 803 are connected to each other through a bus 804. An input/output (I/O) interface 805 is also connected to the bus 804.

Generally, the following apparatuses may be connected to the I/O interface 805: an input apparatus 806 including, for example, a touch screen, a touchpad, a keyboard, a mouse, a camera, a microphone, an accelerometer, a gyroscope, etc.; an output apparatus 807 including, for example, a liquid crystal display (LCD), a speaker, a vibrator, etc.; a storage apparatus 808 including, for example, a magnetic tape, a hard disk, etc.; and a communication apparatus 809. The communication apparatus 809 may allow the electronic device 800 to perform wireless or wired communication with other devices to exchange data. Although FIG. 7 shows an electronic device 800 having various apparatuses, it should be understood that it is not required to implement or have all the apparatuses shown. It may be an alternative to implement or have more or fewer apparatuses.

In particular, according to the embodiments of the present disclosure, the processes described above with reference to the flowcharts may be implemented as computer software programs. For example, an embodiment of the present disclosure includes a computer program product, which includes a computer program carried on a computer-readable medium, and the computer program contains program codes for executing the methods shown in the flowcharts. In such embodiments, the computer program may be downloaded and installed from the network through the communication apparatus 809, or installed from the storage apparatus 808, or installed from the ROM 802. When the computer program is executed by the processing apparatus 801, the above functions defined in the methods of the embodiments of the present disclosure are executed.

It should be noted that the computer-readable medium mentioned above in the present disclosure may be a computer-readable signal medium or a computer-readable storage medium, or any combination of the above two. The computer-readable storage medium may be, for example, but not limited to, electric, magnetic, optical, electromagnetic, infrared, or semiconductor systems, apparatuses, or devices, or any combination of the above. More specific examples of the computer-readable storage medium may include, but are not limited to: an electrical connection with one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, a computer-readable storage medium may be any tangible medium that contains or stores a program that can be used by or in combination with an instruction execution system, apparatus, or device. In the present disclosure, a computer-readable signal medium may include a data signal propagated in a baseband or as a part of a carrier wave, in which computer-readable program codes are carried. This propagated data signal may take a variety of forms, including but not limited to an electromagnetic signal, an optical signal, or any suitable combination of the above. The computer-readable signal medium may also be any computer-readable medium other than the computer-readable storage medium. The computer-readable signal medium may send, propagate, or transmit a program used by or in combination with an instruction execution system, apparatus, or device. The program codes contained on the computer-readable medium may be transmitted by any suitable medium, including but not limited to: wire, optical cable, RF (radio frequency), etc., or any suitable combination of the above.

In some implementations, the client and the server can communicate using any currently known or future developed network protocol, such as the HTTP (HyperText Transfer Protocol) and can be interconnected with any form or medium of digital data communication (such as a communication network). Examples of the communication network include a local area network (“LAN”), a wide area network (“WAN”), an internet (e.g., the Internet), a peer-to-peer network (e.g., an ad hoc network), and any network currently known or to be developed in the future.

The above computer readable medium may be included in the above electronic device, or may exist alone without being assembled into the electronic device.

The above computer readable medium carries one or more programs, and when the one or more programs are executed by the electronic device, the electronic device is caused to execute the above method of the present disclosure.

The computer program code for performing the operations of the present disclosure may be written in one or more programming languages or a combination thereof. The above programming languages include object-oriented programming languages such as Java, Smalltalk, C++, as well as conventional procedural programming languages such as “C” language or similar programming languages. The program code may be executed entirely on a user's computer, partly on a user's computer, as a stand-alone software package, partly on a user's computer and partly on a remote computer, or entirely on a remote computer or a server. In the case related to the remote computer, the remote computer may be connected to the user's computer through any kind of network, including a local area network (LAN) or a wide area network (WAN), or may be connected to an external computer (e.g., connected via the Internet using an Internet service provider).

The flowcharts and block diagrams in the figures illustrate possible architectures, functions and operations of the system, method and computer program product according to various embodiments of the present disclosure. In this regard, each block in the flowchart or block diagram may represent a module, a program segment, or a part of code, which contains one or more executable instructions for implementing a specified logical function. It should also be noted that, in some alternative implementations, the functions indicated in the blocks may also occur in a different order than those indicated in the drawings. For example, two blocks shown one after another may actually be executed substantially in parallel, or they may sometimes be executed in a reverse order, depending on the functions involved. It should also be noted that each block in the block diagram and/or flowchart, and a combination of blocks in the block diagram and/or flowchart, may be implemented by a dedicated hardware-based system that performs a specified function or operation, or may be implemented by a combination of dedicated hardware and computer instructions.

The units involved in the embodiments described in the present disclosure may be implemented in software or hardware. The name of a unit does not constitute a limitation on the unit itself in a certain case.

The functions described above herein may be performed at least in part by one or more hardware logic components. For example, without limitation, exemplary types of hardware logic components that may be used include: a field programmable gate array (FPGA), an application specific integrated circuit (ASIC), an application specific standard product (ASSP), a system on chip (SOC), a complex programmable logic device (CPLD) and so on.

In the context of the present disclosure, a machine readable medium may be a tangible medium that may contain or store a program for use by or in conjunction with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine-readable storage medium may include an electrical connection based on one or more wires, a portable computer disk, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the foregoing.

According to one or more embodiments of the present disclosure, a method for providing a progressive web application is provided, including: determining whether a first website visited by a user through a browser supports the progressive web application; in accordance with a determination that the first website supports the progressive web application, sending a request to an application packaging service in response to a preset operation of the user, such that the application packaging service generates, based on web application configuration information of the first website and preset field information, an application package of a progressive web application of the first website; acquiring the application package; and installing the progressive web application of the first website based on the application package.

According to one or more embodiments of the present disclosure, the preset field information includes a packaging unique identifier, and the method further includes: in response to an instruction for starting the progressive web application of the first website, performing authentication based on the packaging unique identifier; and in accordance with a determination that the authentication succeeds, continuing to run the progressive web application of the first website, or in accordance with a determination that the authentication fails, stopping running the progressive web application of the first website.

According to one or more embodiments of the present disclosure, the packaging unique identifier is generated through encryption based on a start address and a name of the progressive web application of the first website; and the performing authentication based on the packaging unique identifier includes:

decrypting, based on the packaging unique identifier, to obtain the start address and the name of the progressive web application of the first website; and performing a comparison verification between the start address obtained through decryption and an actual start address when the application is actually run, and between the name obtained through decryption and an actual name.

According to one or more embodiments of the present disclosure, the preset field information includes display mode information, and the method further includes: after the authentication succeeds, parsing the display mode information in the application package; and determining, based on the parsed display mode information, a display mode of the progressive web application of the first website.

According to one or more embodiments of the present disclosure, based on determining that the progressive web application of the first website is a 2D progressive web application, the progressive web application of the first website has different user interface styles in different display modes.

According to one or more embodiments of the present disclosure, based on determining that the progressive web application is a 3D progressive web application, the determining, based on the parsed display mode information, a display mode of the progressive web application of the first website includes: generating, based on the parsed display mode information, a loading interface of the progressive web application of the first website.

According to one or more embodiments of the present disclosure, the preset field information includes target control state information; and the method further includes: after the authentication succeeds, parsing the target control state information in the application package; and triggering, based on the target control state information, an event corresponding to a target control.

According to one or more embodiments of the present disclosure, the method further includes: after the progressive web application is started, acquiring local configuration information and online configuration information corresponding to the progressive web application of the first website; comparing the local configuration information with the online configuration information; and determining, based on a comparison result, whether to update the progressive web application of the first website.

According to one or more embodiments of the present disclosure, a package name of a target application is specified in project code of the progressive web application of the first website, such that the progressive web application of the first website is capable of being associated with the target application when being run.

According to one or more embodiments of the present disclosure, a method for providing a progressive web application is provided, including: acquiring, in response to a request sent by a browser, web application configuration information of a first website visited by the browser; determining preset field information, where the preset field information includes at least one of: display mode information, an application packaging unique identifier, or target control state information; generating, based on the web application configuration information and the preset field information, an application package of a progressive web application of the first website; and sending the application package to the browser.

According to one or more embodiments of the present disclosure, the method further includes: generating, through a preset encryption algorithm, the packaging unique identifier based on a start address and a name of the progressive web application of the first website.

According to one or more embodiments of the present disclosure, the determining preset field information includes: determining, based on a type of the progressive web application of the first website, the display mode information.

According to one or more embodiments of the present disclosure, the method further includes: specifying, in project code of the progressive web application, a package name of a target application, such that the progressive web application is capable of being associated with the target application when being run.

According to one or more embodiments of the present disclosure, an apparatus for providing a progressive web application is provided, including: a determination unit, configured to determine whether a first website visited by a user through a browser supports the progressive web application; a request unit, configured to in accordance with a determination that the first website supports the progressive web application, send a request to an application packaging service in response to a preset operation of the user, such that the application packaging service generates, based on web application configuration information of the first website and preset field information, an application package of a progressive web application of the first website; an acquisition unit, configured to acquire the application package; and an installation unit, configured to install the progressive web application of the first website based on the application package.

According to one or more embodiments of the present disclosure, an apparatus for providing a progressive web application is provided, including: an acquisition unit, configured to acquire, in response to a request sent by a browser, web application configuration information of a first website visited by the browser; a determination unit, configured to determine preset field information, where the preset field information includes at least one of: display mode information, an application packaging unique identifier, or target control state information; a generation unit, configured to generate, based on the web application configuration information and the preset field information, an application package of a progressive web application of the first website; and a sending unit, configured to send the application package to the browser.

According to one or more embodiments of the present disclosure, an electronic device is provided, including: at least one memory and at least one processor; where the memory is configured to store program code, and the processor is configured to invoke the program code stored in the memory to cause the electronic device to perform the method for providing a progressive web application provided according to one or more embodiments of the present disclosure.

According to one or more embodiments of the present disclosure, a non-transitory computer storage medium is provided, where the non-transitory computer storage medium stores program code, and the program code, when executed by a computer device, causes the computer device to perform the method for providing a progressive web application provided according to one or more embodiments of the present disclosure.

The above description is only preferred embodiments of the present disclosure and an explanation to the technical principles used. Those skilled in the art should understand that the disclosure scope involved in this disclosure is not limited to the technical solutions formed by the specific combination of the above technical features, and should also cover other technical solutions formed by any combination of the above technical features or their equivalent features without departing from the above disclosed concepts. For example, a technical solution formed by replacing the above features with technical features with similar functions disclosed in the present disclosure (but not limited to).

In addition, although operations are depicted in a particular order, it should not be understood as requiring these operations to be performed in a specific order shown or in a sequential order. Under certain circumstances, multitasking and parallel processing may be beneficial. Similarly, although several specific implementation details are included in the above discussion, these should not be construed as limiting the scope of the present disclosure. Certain features that are described in the context of separate embodiments may also be implemented in combination in a single embodiment. Conversely, various features described in the context of a single embodiment may also be implemented in multiple embodiments separately or in any suitable sub-combination.

Although the subject matter has been described in language specific to structural features and/or logical actions of the methods, it should be understood that the subject matter as defined in the appended claims is not necessarily limited to the specific features or actions described above. Rather, the specific features and actions described above are merely exemplary forms of implementing the claims.

I/We claim:

1. A method for providing a progressive web application, comprising:
determining whether a first website visited by a user through a browser supports the progressive web application;
in accordance with a determination that the first website supports the progressive web application, sending a request to an application packaging service in response to a preset operation of the user, such that the application packaging service generates, based on preset field information and web application configuration information of the first website, an application package of the progressive web application of the first website;
acquiring the application package; and
installing the progressive web application of the first website based on the application package.

2. The method of claim 1, wherein the preset field information comprises a packaging unique identifier, and the method further comprises:
in response to an instruction for starting the progressive web application of the first website, performing authentication based on the packaging unique identifier; and
in accordance with a determination that the authentication succeeds, continuing to run the progressive web application of the first website, or in accordance with a determination that the authentication fails, stopping running the progressive web application of the first website.

3. The method of claim 2, wherein the packaging unique identifier is generated through encryption based on a start address and a name of the progressive web application of the first website; and
wherein performing authentication based on the packaging unique identifier comprises:
decrypting, based on the packaging unique identifier, to obtain the start address and the name of the progressive web application of the first website; and
performing a comparison verification between the start address obtained through decryption and an actual start address when the application is actually run, and between the name obtained through decryption and an actual name.

4. The method of claim 2, wherein the preset field information comprises display mode information, and the method further comprises:
after the authentication succeeds, parsing the display mode information in the application package; and
determining, based on the parsed display mode information, a display mode of the progressive web application of the first website.

5. The method of claim 4, wherein based on determining that the progressive web application of the first website is a 2D progressive web application, the progressive web application of the first website has different user interface styles in different display modes.

6. The method of claim 4, wherein based on determining that the progressive web application is a 3D progressive web application, the determining, based on the parsed display mode information, a display mode of the progressive web application of the first website comprises:
generating, based on the parsed display mode information, a loading interface of the progressive web application of the first website.

7. The method of claim 2, wherein the preset field information comprises target control state information; and
the method further comprises:
after the authentication succeeds, parsing the target control state information in the application package; and
triggering, based on the target control state information, an event corresponding to a target control.

8. The method of claim 1, further comprising:
after the progressive web application is started, acquiring online configuration information and local configuration information corresponding to the progressive web application of the first website;
performing a comparison between the local configuration information and the online configuration information; and
determining, based on a comparison result, whether to update the progressive web application of the first website.

9. The method of claim 1, wherein a package name of a target application is specified in project code of the progressive web application of the first website, such that the progressive web application of the first website is capable of being associated with the target application when being run.

10. A method for providing a progressive web application, comprising:
acquiring, in response to a request sent by a browser, web application configuration information of a first website visited by the browser;
determining preset field information, wherein the preset field information comprises at least one of:
display mode information, an application packaging unique identifier, or target control state information;
generating, based on the web application configuration information and the preset field information, an application package of a progressive web application of the first website; and
sending the application package to the browser.

11. The method of claim 10, further comprising:
generating, through a preset encryption algorithm, the packaging unique identifier based on a start address and a name of the progressive web application of the first website.

12. The method of claim 10, wherein determining the preset field information comprises:
determining, based on a type of the progressive web application of the first website, the display mode information.

13. The method of claim 10, further comprising:
specifying, in project code of the progressive web application, a package name of a target application, such that the progressive web application is capable of being associated with the target application when being run.

14. An electronic device, comprising:
at least one memory and at least one processor;
wherein the memory is configured to store program code, and the processor is configured to invoke the program code stored in the memory to cause the electronic device to:
determine whether a first website visited by a user through a browser supports the progressive web application;
in accordance with a determination that the first website supports the progressive web application, send a request to an application packaging service in response to a preset operation of the user, such that the application packaging service generates, based on preset field information and web application configuration information of the first website, an application package of the progressive web application of the first website;
acquire the application package; and
install the progressive web application of the first website based on the application package.

15. The electronic device of claim 14, wherein the preset field information comprises a packaging unique identifier, and the processor is configured to cause the electronic device to:
in response to an instruction for starting the progressive web application of the first website, perform authentication based on the packaging unique identifier; and
in accordance with a determination that the authentication succeeds, continue to run the progressive web application of the first website, or in accordance with a determination that the authentication fails, stop running the progressive web application of the first website.

16. The electronic device of claim 15, wherein the packaging unique identifier is generated through encryption based on a start address and a name of the progressive web application of the first website; and
wherein the processor is configured to cause the electronic device to:
decrypt, based on the packaging unique identifier, to obtain the start address and the name of the progressive web application of the first website; and
perform a comparison verification between the start address obtained through decryption and an actual start address when the application is actually run, and between the name obtained through decryption and an actual name.

17. The electronic device of claim 15, wherein the preset field information comprises display mode information, and the processor is configured to cause the electronic device to:
after the authentication succeeds, parse the display mode information in the application package; and
determine, based on the parsed display mode information, a display mode of the progressive web application of the first website.

18. The electronic device of claim 15, wherein the preset field information comprises target control state information; and the processor is configured to cause the electronic device to:
after the authentication succeeds, parse the target control state information in the application package; and
trigger, based on the target control state information, an event corresponding to a target control.

19. The electronic device of claim 14, wherein the processor is configured to cause the electronic device to:
after the progressive web application is started, acquire online configuration information and local configuration information corresponding to the progressive web application of the first website;
perform a comparison between the local configuration information and the online configuration information; and
determine, based on a comparison result, whether to update the progressive web application of the first website.

20. The electronic device of claim 14, wherein a package name of a target application is specified in project code of the progressive web application of the first website, such that the progressive web application of the first website is capable of being associated with the target application when being run.
